(19) United States
(12) Patent Application Publication
(10) Pub. No.: US 2025/0379747 A1
(43) Pub. Date: Dec. 11, 2025

(54) ENHANCED INTERNET OF THINGS SENSOR ANALYSIS AND REAL-TIME TRUST PROVENANCE DETERMINATION

(71) Applicant: Analog Devices International Unlimited Company, Co. Limerick (IE)

(72) Inventors: Aengus Gorey, Limerick (IE); Jerry Teahan, Fermoy (IE); Rolf E. Halthen, Greer, SC (US); Stephane Di Vito, La Ciotat (FR)

(21) Appl. No.: 19/233,421

(22) Filed: Jun. 10, 2025

Related U.S. Application Data
(60) Provisional application No. 63/658,320, filed on Jun. 10, 2024.

(51) Int. Cl. H04L 9/32; G16Y 40/50

(52) U.S. Cl. CPC H04L 9/3247; G16Y 40/50

(57) ABSTRACT

Systems and methods are disclosed for enhanced internet-of-things sensor analysis and real-time trust provenance determination. An example method includes determining a subset of a plurality of IoT sensors from which data is to be aggregated, the subset of the plurality of IoT sensors being responsive to one or more constraints, wherein individual IoT sensors are configured to generate data provenance information which, at least, cryptographically identifies data as originating from the individual IoT sensors; instructing the subset of the IoT sensors to generate data, wherein a first IoT sensor of the subset is instructed to execute a custom workload, and wherein the data provenance information generated via the first IoT sensor is to be cryptographically signed; and aggregating output data associated with the subset of the IoT sensors, wherein data provenance information associated with the IoT sensors is validated to form a trusted network chain.

### CROSS-REFERENCE TO RELATED APPLICATIONS

This application claims priority to U.S. Prov. Patent App. No. 63/658,320 titled “SYSTEMS AND METHODS FOR TRUSTED DATA GENERATION AND TRANSPORTATION” and filed on Jun. 10, 2024, the disclosure of which is hereby incorporated herein by reference in its entirety.

### BACKGROUND

### Technical Field

The described technology generated relates to internet of things (IoT) devices, and more particularly to data provenance associated with the IoT devices.

### Description of the Related Art

Internet-of-Things (IoT) devices are devices with physical hardware that enables transmission of data over a network. IoT devices are increasingly being leveraged to enable, for example, transmission of sensor data directly from the source. For example, an IoT device may represent a sensor which is able to transmit its own sensor data over a network. IoT devices may additionally include smart home technologies, such as lighting devices, thermostats, security systems, and so on. IoT devices may additionally include manufacturing devices which allow for fine-grained control of manufacturing steps along with detailed reporting of information associated with the manufacturing steps.

The capability of these IoT devices to be connected to a network, such as the Internet, allow for real-time communications with end-user devices or other IoT devices. For example, an end-user device may receive real-time alerts from a security system. As another example, an end-user device may compute a forward pass through a machine learning model of substantially real-time sensor data from an IoT device.

### SUMMARY

In some embodiments, a system is described. The system includes a plurality of internet-of-things (IoT) sensors, wherein individual IoT sensors are configured to generate data provenance information which, at least, cryptographically identifies data as originating from the individual IoT sensors; and one or more processors in communication with non-transitory computer storage media storing instructions that when executed by the one or more processors, cause the one or more processors to: determine a subset of the IoT sensors from which data is to be aggregated, the IoT sensors being responsive to one or more constraints; instruct the subset of the IoT sensors to generate data, wherein a first IoT sensor of the subset is instructed to execute a custom workload, and wherein the data provenance information generated via the first IoT sensor is to be cryptographically signed; and aggregate output data associated with the subset of the IoT sensors, wherein data provenance information associated with the IoT sensors is validated to form a trusted network chain.

In some embodiments, a method is described. The method is implemented by a system of one or more processors. The method comprises determining a subset of a plurality of IoT sensors from which data is to be aggregated, the subset of the plurality of IoT sensors being responsive to one or more constraints, wherein individual IoT sensors are configured to generate data provenance information which, at least, cryptographically identifies data as originating from the individual IoT sensors; instructing the subset of the IoT sensors to generate data, wherein a first IoT sensor of the subset is instructed to execute a custom workload, and wherein the data provenance information generated via the first IoT sensor is to be cryptographically signed; and aggregating output data associated with the subset of the IoT sensors, wherein data provenance information associated with the IoT sensors is validated to form a trusted network chain.

In some embodiments, non-transitory computer storage media is described. The non-transitory computer storage media is configured to be executed by a system of one or more processors to perform operations comprising Determining a subset of a plurality of IoT sensors from which data is to be aggregated, the subset of the plurality of IoT sensors being responsive to one or more constraints, wherein individual IoT sensors are configured to generate data provenance information which, at least, cryptographically identifies data as originating from the individual IoT sensors; instructing the subset of the IoT sensors to generate data, wherein a first IoT sensor of the subset is instructed to execute a custom workload, and wherein the data provenance information generated via the first IoT sensor is to be cryptographically signed; and aggregating output data associated with the subset of the IoT sensors, wherein data provenance information associated with the IoT sensors is validated to form a trusted network chain.

In some embodiments, a method is described, The method is implemented by a user device of one or more processors. The user device is configured to present an interactive user interface associated with a system in communication with a plurality of IoT sensors, wherein individual IoT sensors are configured to generate data provenance information which, at least, cryptographically identifies data as originating from the individual IoT sensors, and wherein the interactive user interface: presents graphical representations of a plurality of IoT sensors which are responsive to constraints specified via a user of the interactive user interface, wherein a subset of IoT sensors is selected based on the graphical representations, identifies, for a first IoT sensor of the subset, expanded functionality capable of performance via the first IoT sensor, wherein the custom workload is configured to leverage the expanded functionality, and triggers information to the subset reflecting their aggregation, wherein the system is configured to receive data from the subset, and wherein the system is configured to validate the data provenance information included in the received data.

### BRIEF DESCRIPTION OF THE DRAWINGS

The following drawings and the associated description herein are provided to illustrate specific embodiments of the disclosure and are not intended to be limiting.

FIG. 1A is a block diagram of an example analysis system aggregating disparate sensors to form an example trusted network chain.

FIG. 1B is a block diagram of an example sensor that forms part of the example trusted network chain.

FIG. 1C is a block diagram of an example OEM sensor that forms part of the example trusted network chain.

FIG. 2 is an example user interface associated with forming a trusted network chain.

FIG. 3 is a block diagram of an example analysis system presenting a user interface associated with trust information from a data source.

FIG. 4A is a block diagram of example data sources and nodes which form paths to the example analysis system.

FIG. 4B is a block diagram of the example analysis system generating an aggregated trust score associated with a path from an example data source.

FIG. 5 is a flowchart of an example process for causing aggregation of IoT data which based on a trust framework as described herein.

FIG. 6 is a flowchart of an example process for generating an aggregated trust score associated with a data source.

FIG. 7 is a flowchart of an example process for enabling selection of a data source based on one or more aggregated trust scores.

### DETAILED DESCRIPTION

This application describes techniques to enable trustability of data from disparate edge devices or data sources, such as an internet-of-things (IoT) sensor. For example, the techniques described herein may provide a trust framework in which a trusted network chain from one or more sensors, through network elements, to cloud-connected or consumer processing devices, is formed. In this example, a user may obtain data from particular sensors along with proof, such as cryptographically verified proof, that the obtained data authentically originated at the sensors and was not adjusted during transference to the user. As will be described, the trust framework may enable complex data processing schemes in which trustability of data is paramount. As one example, users may train complex machine learning models, such as neural networks, based on substantially real-time aggregated data with assurances that the data reflects accurate sensing measurements.

Sensors, such as IoT sensors, are increasingly being relied upon to make decisions. Indeed, IoT sensors are being relied upon as a basis for autonomous decisions. However, today's intelligent edge has a trust issue that is 2-fold: the quality of the data collected from the edge, such as IoT sensors, is unknown, and the integrity/authentication of the data is hard to guarantee.

As an example of an autonomous decision, a manufacturer may leverage a multitude of IoT sensors to inform different aspects of manufacturing. For example, a first set of sensors may monitor for foreign or particulate matter while a second set of sensors may monitor precise temperature changes. In this example, data from the sensors may be routed over disparate networks and processed via autonomous agents or software. The software may, as an example, be processed via a cloud system located at an arbitrary distance from the sensors. At present, there is no technique by which the autonomous agent or software can ensure immutability of the data and ensure that that the data originates at the sensors themselves (e.g., ensure data provenance).

Furthermore, it is increasingly importance to obtain high quality training data for use in training machine learning models. At present, an entity may be required to rely on training data sets from third-parties where the training data is a black box. This lack of transparency into the training data itself may limit an extent to which such machine learning models are able to be used.

As will be described, this application describes techniques to enable a trust framework in which users can rapidly identify, and then obtain data from, a set of sensors. Advantageously, as the data travels from the sensors to a system, such as the analysis system 100 described herein or a user-defined endpoint, information ensuring the data's provenance and trustability may persist with the data. Example information may include data provenance information which may cryptographically associate data with a particular sensor. Example information may further include a trust score which may reflect measures of trust associated with the data. Reference to herein to data or obtained data may reflect, in some embodiments, individual messages, data packets, and so on. Thus, individual messages, data packets, from an IoT sensor may include data provenance information such as all, or a subset of, information included in the messages, data packets, and so on, being cryptographically signed.

In some embodiments, the sensors described herein may include processing elements capable of performing customized user defined workloads. The sensors may additionally include processing elements capable of generating data provenance information, which as one example may include signing (e.g., via a private key) measurements or information generated via the sensors. In general, an without being constrained by way of example, data provenance information may include information which cryptographically persists with the data. The information may reflect, in some embodiments, a ledger or other information which includes one or more of an identification of a sensor, metadata associated with the sensor, sensor measurements, arbitrary processing performed via the sensor, and so on. These sensors may, in some embodiments reflect enhanced IoT sensors which form the trust framework described herein.

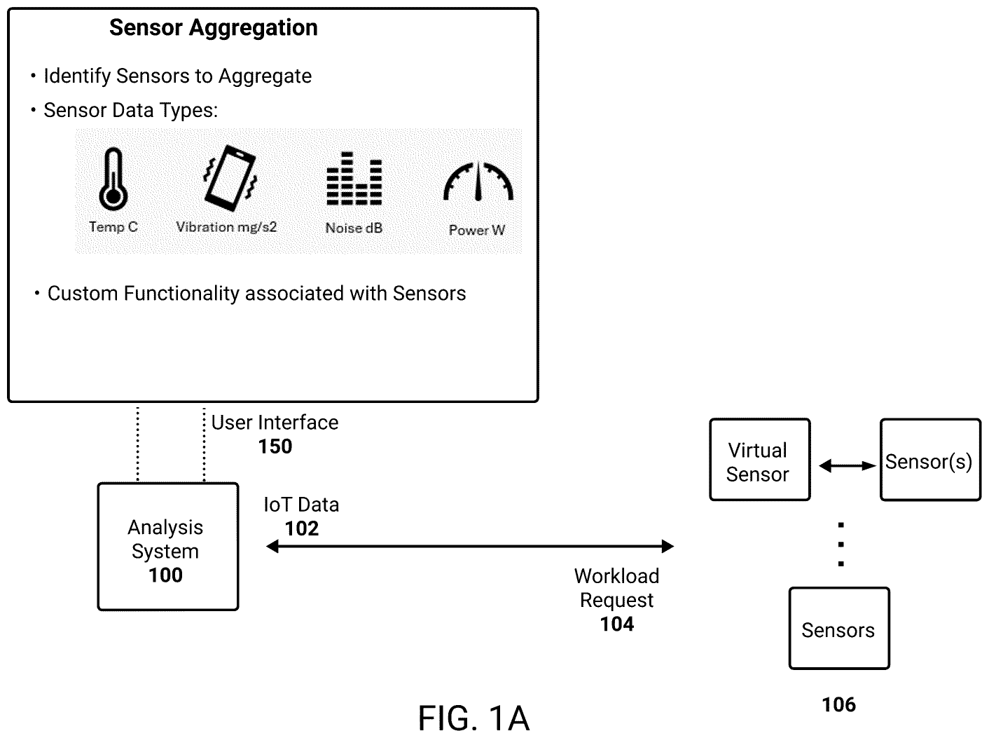

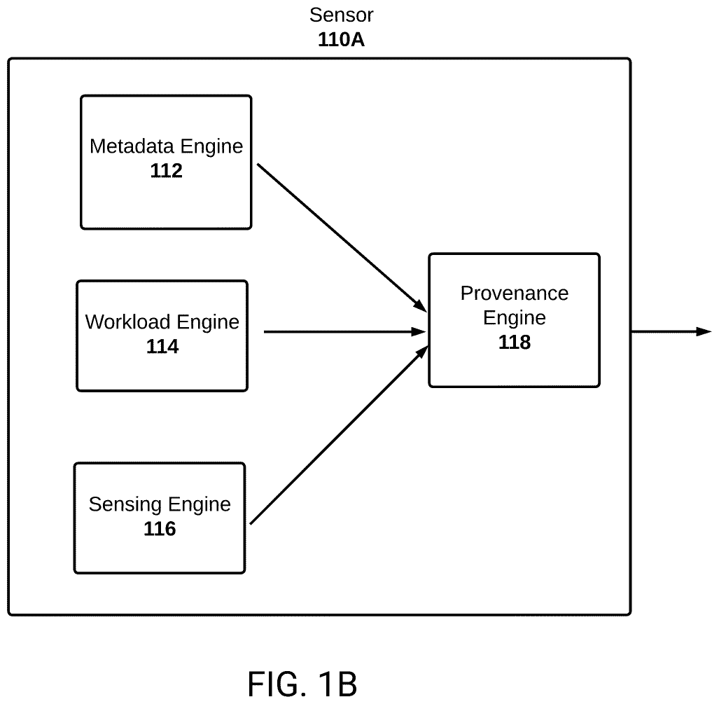

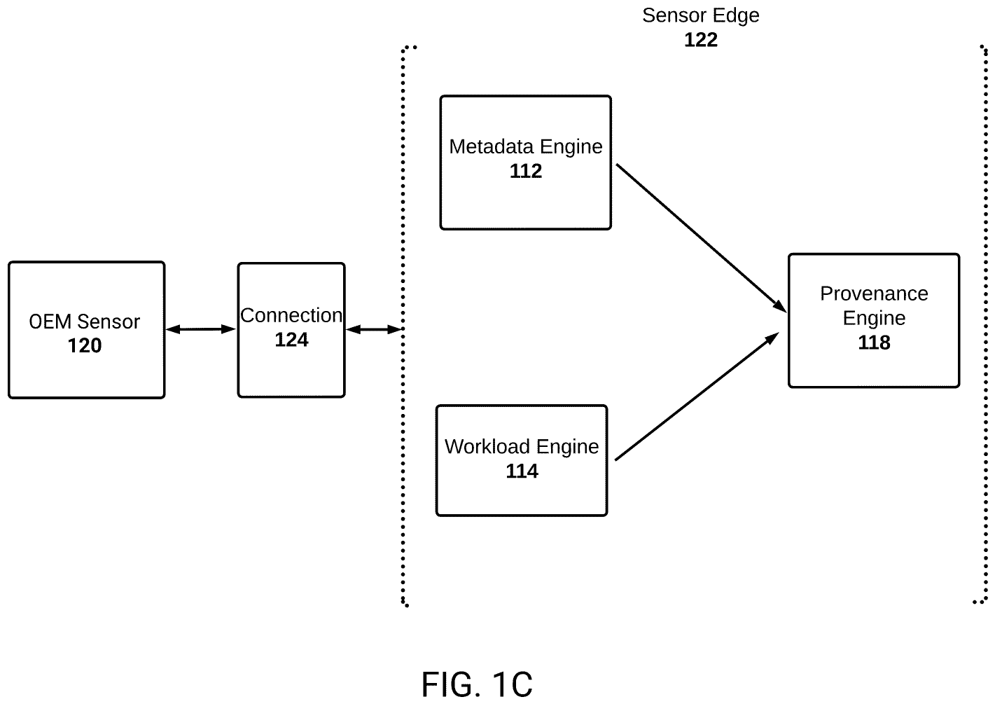

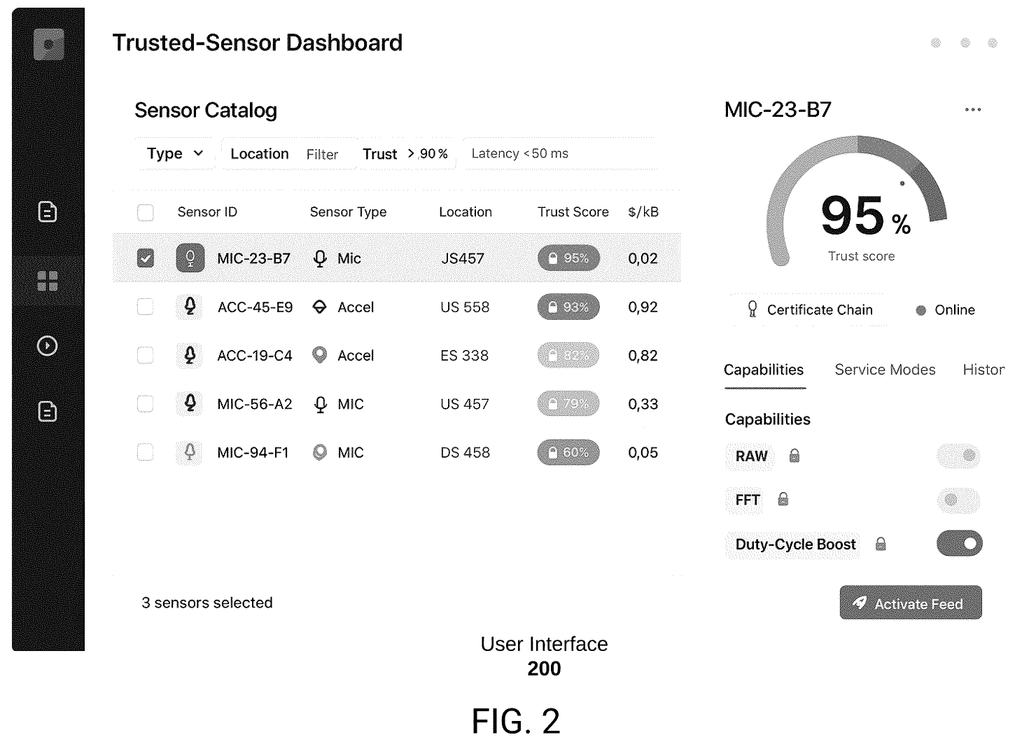

With respect to these enhanced IoT sensors, users may surface sensors that correspond to particular constraints of interest to the users. For example, and as illustrated in FIGS. 1A and 2, a user may leverage a user interface that enables aggregation of particular sensors for a customized user. Advantageously, the user may cause customized, or enhanced, functionality via the aggregated sensors.

As one example, the user may be searching for audio sensors (e.g., microphones) which have a particular use (e.g., noise cancellation functionality). For this example, the audio sensors may typically respond to a particular frequency range (e.g., a human audible frequency range). However, the user may prefer that the audio sensors open up this frequency band or response. For example, the user may be developing a machine learning model associated with noise cancellation and prefer the richer data set. The system described herein (e.g., the analysis system 100) may cause these sensors to subsequently obtain the expanded audio measurements (e.g., for a threshold amount of time).

The IoT sensors may additionally be instructed to perform arbitrary processing based on their sensor measurements. For example, an IoT sensor described herein (e.g., the sensor 110A in FIG. 1B) may process (e.g., locally process, such as edge computing) the sensor measurements. Int his example, the IoT sensor may cryptographically associated data provenance information with the generated information from the IoT sensor (e.g., the processed information, sensor measurements, and so on). Thus, the data provenance information may persist with the generated information through a signal chain to the user (e.g., forming a trusted network chain).

In some embodiments, virtual sensors may be used by the system described herein. For example, a virtual sensor may reflect a front-end associated with a set of sensors. In this example, the virtual sensor may be an edge device or server which is in communication with the set of sensors. The above-described user may select, or otherwise identify, the virtualized sensor as an abstraction of the underlying set of sensors. Advantageously, complex processing may be performed via the virtualized sensor. For example, the virtual sensor may perform custom processing, such as sanitization, augmentation, aggregation, and so on, based on information received from the set of sensors. Using the techniques described herein, data provenance of the set of sensors may be guaranteed such that the user may leverage the virtual sensor to more succinctly obtain data.

Standard manufactured sensors, such as original equipment manufacturer (OEM) sensors, may, in some embodiments, be augmented for use in the trust framework described herein. For example, and as illustrated in FIG. 1C, an OEM sensor may be connected to a sensor edge element. In this example, the sensor edge element may associate data provenance information with output from the OEM sensor. Additionally, in some embodiments the sensor edge element may enable the above-described custom processing or workloads.

As data moves from the sensors to an endpoint, such as the system 100 or a user-defined network location, data provenance information may live, or otherwise maintain association with, the data. For example, a private key may be used to cryptographically sign the data prior to leaving a sensor. In this example, the endpoint, or the user, may use a public key to ensure that the private key was used. In some embodiments, subsequent nodes through which the data flows may similarly cryptographically sign the data. For example, a merkle tree may be performed reflecting identifies of the sensors, nodes, and so on, which are associated with obtained data. In this example, each node may append information (e.g., a ledger, record, and so on), such as signed information, to the received data's lineage thus forming an immutable verifiable chain.

In some embodiments, individual sensors may added to the trust framework described herein using example technologies. For example, FIDO Device Onboard (FDO) techniques may be used to onboard individual sensors. In this example, when a sensor powers on it may transmit the device's public key, or certificate chain, to an endpoint or service associated with, or otherwise accessible to, the system described herein. In this way, users, systems, and so on, may access and utilize the public keys.

In addition to the above-described data provenance information, the disclosed technology may determine measures of trust associated with data provenance of different data sources. As described above, an example data source may include a sensor, such as an internet-of-things (IoT) sensor. Another example data source may include an arbitrary IoT device, such as security system. Another example data source may include an arbitrary device, such as a tablet, laptop, cloud-connected database, and so on. As will be described, measures of trust (herein referred to as trust scores) may be determined along a path from a data source to an ending location (e.g., an endpoint). The ending location may represent, for example, the system described herein or a device used by a customer or user which receives data from the data source.

Each node in a path may assign a trust score which is associated with data from the data source, for example the trust scores may be metadata associated with the data. A node may represent a hardware, or software, component through which data flows. Example nodes may include a compute instance, memory element, database, co-processor or communication interface, gateway, firewall, switch, hub, and so on.

As will be described, each node in the path may generate a trust score which may, as an example, persist with the data as it travels along the path. In some embodiments, the node may determine its trust score based on analyses of its hardware and/or software (e.g., software bill of materials). As one example, the node may determine that it has recent security updates or that there are no known common vulnerability and exposures (CVEs). As another example, the node may assign a higher trust score if the node has a hardware-level trusted platform module (TPM) rather than a firmware-based TPM. As another example, the node may assign a higher trust score for a more advanced security algorithm (e.g., higher key size, advanced encryption mode, and so on). The node may, in some embodiments, determine a trust score based on weighting different characteristics of its hardware and/or software.

Thus, different trust scores may be associated with data from a data source as the data moves from the data source along a path. For example, a data source (e.g., an IoT device) may assign a first trust score to data being generated otherwise being transmitted by the data source. An initial node may receive the data along with the first trust score (e.g., as metadata). The initial node may then generate a second trust score. The first trust score and second trust score may then be transmitted (e.g., as metadata) along with the data to a subsequent node. In some embodiments, the individual trust scores (e.g., the first trust score and second trust score) may be included in the transmission. In some embodiments, a node may generate a single trust score based on its own trust score and a received trust score from an earlier node in the path.

The above-described ending location, such as the system 100 described herein, may determine an aggregated trust score associated with the data. Advantageously, a user or customer may use customized, or otherwise user configurable, techniques to determine the aggregated trust score. As one example, the aggregated trust score may represent a measure of central tendency associated with the received trust scores. In this way, the user or customer may determine how the data is to be used based on the aggregated trust score. For example, the user may prefer to only use higher trust data for certain purposes (e.g., training of machine learning models). As another example, the user may allow use of lower trust data for other purposes (e.g., non-safety or security tasks which are not critical), such as data with a short lifecycle or short usage path.

In some embodiments, the user may update a path through which particular data flows to adjust an aggregated trust score. For example, the user may prefer to use data from a particular data source. In this example, the aggregated trust score may indicate that the data is not trustworthy (e.g., the score may be below a threshold or within a particular range associated with lower trust data). The user, or an automated process or system, may identify a different path from the data source through nodes that enable an increase in the aggregated trust score.

In some embodiments, the ending location (e.g., the system 100) may automatically update data sources being used based on the aggregated trust scores. For example, data from a data source may be associated with a first aggregated trust score. In this example, the data may suddenly be associated with a second, lower, aggregated trust score. For this example, one or more nodes in a path from the data source to the ending location may have updated their trust scores to be lower. The ending location may therefore automatically cut off access to this data source. Similarly, the ending location may connect to, or otherwise integrate data from, a data source which has an aggregated trust score that is suddenly greater than a threshold.

Due to the proliferation of IoT devices, their deployment in diverse and uncontrolled environments, the continuous influx of new devices into various networks has created unprecedented numbers of sources from which data is created. It is now becoming crucial to ensure security of the data at the point of creation, including source, environment and other parameters impacting data creation. As more and more data is created by the different IoT devices, making good use of this data is a new paradigm shift in how data may be used at the point of creation. Thus, employing this data as it is created on the edge device to benefit different application use cases is a space which is becoming increasingly important.

The techniques described herein provide for a trust score to be a part, as an example, of the metadata (e.g., associated with the data created at an IoT device). The trust scores, as described above, may be across different layers in which data has been processed. An example first layer may be the sensor data at the point of creation. An example second layer may represent a node within a gateway in which the data get processed. Each time the data gets processed through a node; a new trust score is associated with the metadata.

While IoT sensors are described herein, as may be appreciated an arbitrary data source may similarly form part of the trust framework described herein. For example, databases, event data sources, stream processing sources, and so on may leverage the techniques to cryptographically guarantee data at the data source.

The above and other aspects will now be described in more detail.

### Example Block Diagrams

FIG. 1 is a block diagram of an example analysis system 100 presenting a user interface 150 associated with sensor aggregation. In the illustrated example, the analysis system 100 may represent a system or device which receives internet-of-things (IoT) data 102 from one or more sensors 106. As an example, the system 100 may represent a cloud system, virtual machine, physical computer, laptop, tablet, and so on. The IoT data 102 may be received over a network, such as a local or wide area network, the Internet, and so on. The sensors 106 may represent sensors measuring, or otherwise obtaining, arbitrary information, such as sensors used in manufacturing, as environmental sensors, as cameras, and so on.

User interface 150 may represent a user interface that may be used via a user to enable the system 100 to obtain the IoT data 102. The user interface 150, in some embodiments, may be presented via the analysis system 100, for example as a web application. The user interface 150 may additionally be presented via a front-end presentation system in communication with the analysis system 100. The user interface 150 may reflect a user interface associated with a mobile application.

In the illustrated example, the user interface 150 includes functionality to identify sensors for aggregation. The user may identify types of sensors of interest. For example, the user may indicate that the user is looking for sensors that measure audio. The user may additionally include complex constraints or queries, for example causing the identification of sensors that measure audio corresponding to certain constraints (e.g., audible audio, audio used in frequency-shift keying modems, and so on). Additionally constraints may include geographic locations, sensitivity of sensor measurements, inclusion in particular devices, inclusion in particular contexts (e.g., manufacturing), and so on.

Upon indication of constraints or queries, the analysis system 100 may access an index or catalog associated with sensors. The index or catalog may reflect sensors which are capable of forming the trust framework described herein. For example, the sensors may be required to include functionality to associate data provenance information with obtained sensor data. As described herein, data provenance information may cryptographically guarantee that data comes from a particular sensor. For example, the data provenance information may include an identifier (e.g., a unique identifier) associated with a sensor. As another example, the data provenance information may include a location associated with the sensor. As another example, the data provenance information may include individual timestamps associated with individual data points or sensor measurements.

The index or catalog may be generated, in some embodiments, via the system 100. For example, new sensors may be onboarded using, as one example, FDO. In this example, a sensor may connected to a network. The sensor may then broadcast its public key or certificate chain to an endpoint accessible to, or implemented by, the system 100. Additionally, the sensor may include information reflecting its functionality or other constraints (e.g., location, use, and so on). Thus, the sensors may reflect IoT sensors which may be in different parts of the world, connected to different network, different intranets, and so on. In some embodiments, the user may identify specific sensors for use in aggregation of sensor data or measurements, such as via unique identifiers, network endpoints or locations, and so on.

In FIG. 1A, the user interface 150 indicates that the sensors may obtain temperature, vibration information, noise information, power information, and so on. In some embodiments, the user interface 150 may indicate expanded functionality as compared to nominal operation of the sensors. As an example described above, a microphone may typically record audio measurements within an audible frequency range of a human. However, the microphone may be capable of an expanded audible frequency range. Thus, the user may specify that the expanded frequency range be used. Furthermore, certain sensors may have secondary, or additional, functionality as compared to their primary purpose. As one example, a sensor may be used to measure phase shift such as in a coriolis mass flow meter. For this example, the sensor may additionally measure vibration. As may be appreciated, excessive vibrations may result in inaccurate phase shifts such that the user may prefer to discard certain measurements from the sensor.

The user may additionally cause custom functionality to be performed via the sensors. For example, the user may cause edge or local processing via the sensors 106. As one example, an individual sensors may include, or be in local communication with, microcontroller units (MCUs) or other processors which are capable of processing sensor measurements from the individual sensor. The user may, as an example, enable local processing of a fast fourier transform (FFT). The user may also cause custom functionality to be performed by certain sensors but not others. The user may also cause first custom functionality to be performed via a first set of sensors and second custom functionality to be performed via a second set of sensors. Thus, the user indicate this custom functionality which is to be performed via individual sensors. The custom functionality may enable third-party, digitally signed workloads (e.g., agents) running on edge modules. The agents may have their identities/custom codes included in the data provenance information (e.g., the code may be hashed and that value persist with the data).

As described herein, certain sensors of the sensors 106 may include virtual sensors. These virtual sensors may represent abstractions of sensors, for example a virtual sensor may be associated with 5, 10, 50, 1000, and so on sensors). A virtual sensor may represent a useful abstraction for a user to easily identify a grouping of sensors that conform to the user's constraints. For example, the user may select a virtual sensor that is associated with microphones used for noise cancelation in consumer-level, or professional-level, headphones. The virtual sensor may reflect an arbitrary system or device, for example a cloud system, cloud agent, serverless agent, computer system, aggregation of graphics processing units with network functionality, and so on. The user may therefore identify, as an example, complex custom functionality to be applied to data associated with the virtual sensors. For example, the virtual sensor may implement a forward pass through a neural network. As another example, the virtual sensor may perform complex time series processing, stream processing, filtering, and so on.

In the illustrated example, the analysis system 100 is providing a workload request 104 to identified sensors 106. These sensors 106 may provide sensor measurements to the system 100 (e.g., IoT data 102). The sensors 106 may provide sensor measurements to a particular endpoint or network location set by the user. As described herein, the sensors 106 may cryptographically guarantee data provenance. For example, the sensors 106 may sign generated information using individual private keys. Furthermore, in some embodiments, nodes (e.g., network nodes) which cause the data from the sensors 106 to be transmitted to the system 100 or endpoint may additionally generate cryptographic information. For example, the nodes may associate data provenance information reflecting unique identifiers associated with the nodes. In this way, the user may obtain assurances of the data provenance (e.g., from the sensors 106) along with cryptographically guaranteed indications of the network hops to the system 100 or endpoint. Additional techniques besides public keys/private keys may be used and fall within the scope of the disclosure herein. For example, distributed hashes may be used. As another example, message authentication code techniques (e.g., HMAC, CMAC, and so on), symmetric encryption, and so on may be used.

The analysis system 100, or an endpoint, may thus receive the IoT data 102 for transmission to the user. The system 100 may additionally ensure data provenance associated with the sensors 106. For example, the system 100 may ensure that cryptographic guarantees associated with the sensors 106 are included therein. As one example, the system 100 may access public keys associated with the sensors 106. The system 100 may then ensure that the signed sensor measurements from the sensors 106 are cryptographically associated with private keys of the sensors 106. Similarly, the system 100 may access public keys associated with nodes through which the IoT data 102 traveled.

With respect to the above, the system 100 may automatically identify portions of IoT data 102 for which data provenance could not be verified. For example, the system 100 may determine that a particular node failed to sign the data it received. In this example, the system 100 may discard, or otherwise flag or identify, data from the particular node. The system 100 may optionally adjust a network path such that data no longer flows through the particular node (e.g., the system 100 may instruct nodes, such as a node prior to the particular node, not to use the particular node). Similarly, the system 100 may determine that a sensor failed to sign the data or that the signing was invalid. The system 100 may thus discard, or otherwise flag, the data.

While the description above focused on a user, as may be appreciated autonomous or semi-autonomous agents or software may cause aggregation of sensors 106. For example, an autonomous agent may determine that a machine learning model may benefit from training data of a particular type. In this example, the autonomous agent may utilize the system 100 to identify corresponding sensors. The agent may, as an example, utilize an application programming interface (API), endpoints, and so on. Similarly, while a user interface is described, a user may similarly leverage an API, endpoints, and so on.

FIG. 1B is a block diagram of an example sensor 110A that forms part of an example trusted network chain. The sensor 110A may reflect a sensor that natively may from the trust framework described herein. For example, the sensor 110A may include sensing elements (e.g., a sensing engine 116) which may measure, or otherwise determine, changes or properties of an environment. The sensor 110A may additionally include microcontrollers or processing elements (e.g., on a same board or otherwise in communication with the sensing engine 116) that form the data provenance techniques described herein.

In the illustrated example, the sensor 110A includes a metadata engine 112. The metadata engine 112 may collect metadata associated with the sensor 110A (e.g., a unique identifier of the sensor, time stamps, location, capabilities, and so on). As one example described herein, a sensor may determine measures of vibration. In this example, metadata may include these measures. Another example of metadata may include electrical network faults for a sensor associated with electricity metering. Another example of metadata may include fluid flow turbulence for a sensor associated with flow metering. Thus, the metadata engine 112 may collect arbitrary metadata from the sensor 110A. The metadata may be definable by a user or may reflect additional capabilities of the sensor 110A.

The sensor 110A includes a workload engine 114 which may cause performance of arbitrary processing. For example, the sensor 110A may generate an FFT as described above with respect to FIG. 1A (e.g., the sensor 110A may aggregate measurements and then determine a frequency characterization).

The sensor 110A includes a provenance engine 118. As described above, the sensor 110A may generate cryptographic proof or guarantee associated with data provenance (e.g., referred to herein as data provenance information). In some embodiments, the sensor 110A may cryptographically sign information received from engines 112, 114, and 116. In some embodiments, the engine 118 may leverage Device Identifier Composition Engine (DICE) techniques to update, or generate a new, private key (e.g., on reboot). The public key and/or certificate chain may be transmitted to the system 100 (e.g., the system 100 may validate the chain) for use in validating data provenance associated with the sensors 110A. For example, this may allow the sensor 110A to avoid use of a more complex trusted platform module (TPM) chip.

The output of the sensor 110A may be transmitted downstream, for example to a node. In some embodiments, the node may validate the data provenance information. For example, the node may access a public key associated with the sensor 110A. In some embodiments, the node may further add data provenance information. For example, the node may sign the received data using a private key.

FIG. 1C is a block diagram of an example OEM sensor 120 that forms part of the example trusted network chain. In some embodiments, an OEM sensor 120 may be adjusted for use in the trust framework described herein. For example, the OEM sensor 120 may be connected (e.g., via a connection 124) to a sensor edge element 122. For example, the sensor edge element 122 may interface with the OEM sensor via I²C, CAN bus, UART, SPI, USB, and so on. Advantageously, the sensor edge element 122 may include the metadata engine 112, workload engine 114, and provenance engine 118 described above.

Output from the OEM sensor 120, such as sensor measurements, may thus be associated with data provenance information (e.g., via the provenance engine 118). The sensor edge 122 may include network functionality to enable transference of the data downstream to an endpoint (e.g., the system 100). Similar to the above, in some embodiments the sensor edge element 122 may use example techniques, such as FDO, to enable discoverability or onboarding of the sensor 120.

Additionally, metadata and output associated with custom processing may be transmitted from the sensor edge 122. The workload engine 114 may apply custom processing as described above. In some embodiments, the workload engine 114 may interface with the OEM sensor 120, such as controlling aspects of the sensor 120 (e.g., writing to the control registers of the sensor 120). Iin this way, the engine 114 may enable additional functionality or otherwise cause specific behavior related to the custom processing.

FIG. 2 is an example user interface 200 associated with forming a trusted network chain. In the illustrated example, the user interface 200 identifies a multitude of sensors along with a sensor type. The user interface 200 further indicates a trust score associated with the sensor, which is described in more detail below. A user of the user interface 200 may specify constraints or types of sensors of interest to the user. The suer may select some, or all, of the surfaced sensors to obtain data as described herein. Advantageously, the data may be assured to be trustable based on the data provenance information described herein.

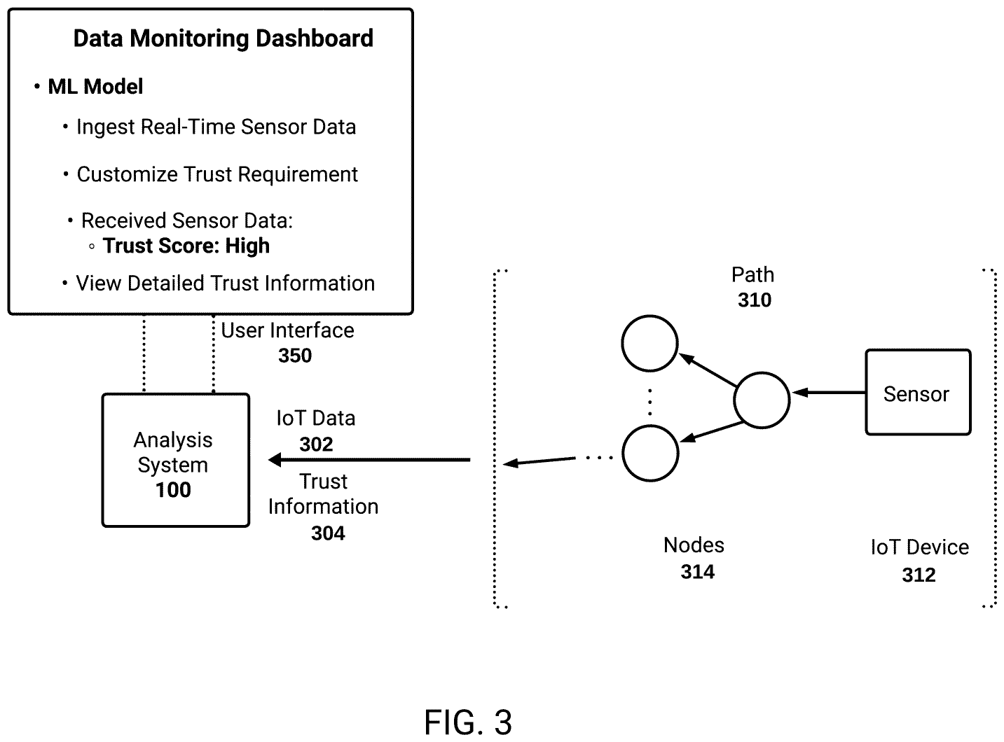

FIG. 3 is a block diagram of the example analysis system 100 presenting a user interface 350 associated with trust information 304 from a data source 312. In the illustrated example, the analysis system 100 may represent a system or device which receives information (e.g., IoT data 302) from one or more paths (e.g., path 310).

As known by those skilled in the art, the IoT device 312 may provide information over a network to one or more nodes 314. Example nodes may include, for example, a gateway, a firewall, a switch, a hub, a compute instance, a memory element, a co-processor, a communication interface, a database, another IoT device, or any arbitrary device or system which is configured for connection to the network. The path 310 may be formed from a set of these nodes 314. For example, the path 310 may include the IoT device 312 and one node. The path 310 may also include the IoT device 312 and two nodes, five nodes, one hundred nodes, and so on.

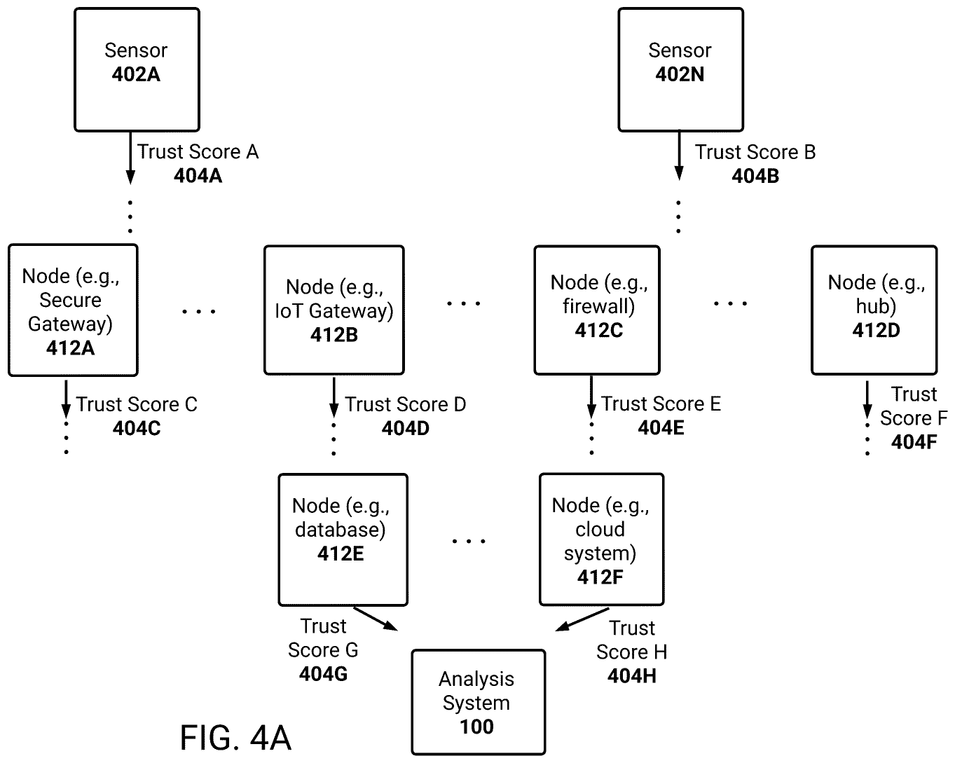

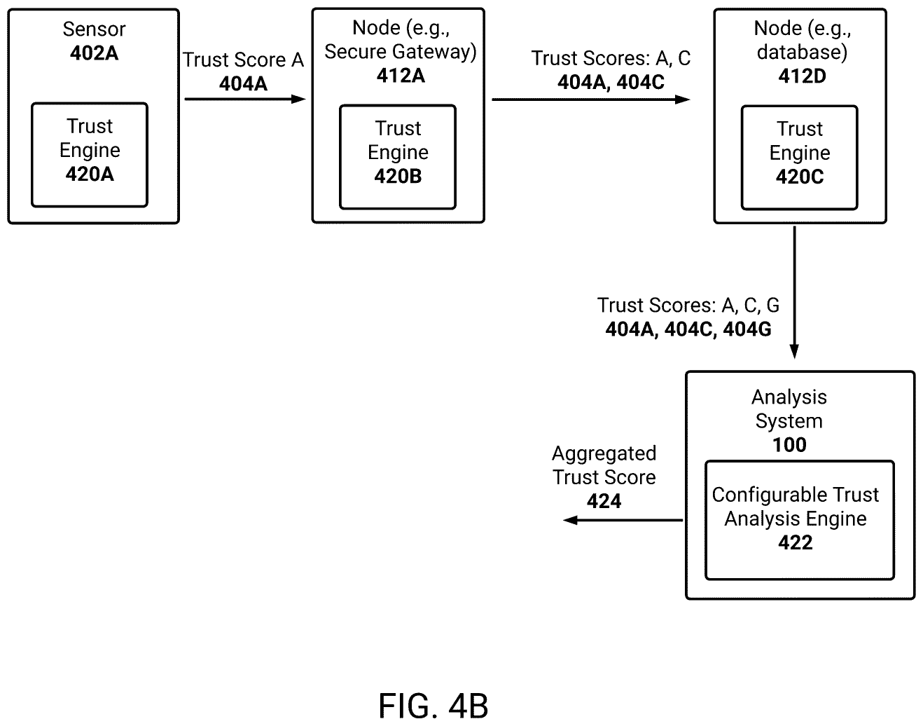

As described herein, the IoT device 312 and nodes 314 may determine individual trust scores. For example, the IoT device 312 may determine its own trust score. As another example, each of the nodes 314 may determine its own trust score. Examples of determining a trust score are described in more detail below, with respect to FIGS. 4A-4B. the trust scores may be provided as metadata associated with the IoT data 302. In FIG. 3, the trust scores are included in the trust information 304 which is provided along with the IoT data 302.

In some embodiments, each node may sign, or otherwise cryptographically protect, its trust score. For example, each node may have a private key which is used to sign the trust score. In this example, the analysis system 100 may use an associated public key to verify that the trust score has not been tampered with. As another example, a cryptographic hash may be used. The trust score may thus form part of the data provenance information described herein or may reflect additional information which is cryptographically guaranteed. In some embodiments, each node downstream in the path 310 may sign, or cryptographically hash, the trust scores received from nodes upstream in the path 310 (e.g., closer to the device 312). Thus, a merkle tree or other technique may be used to ensure accuracy of the received trust scores.

The analysis system 100 is illustrated as presenting user interface 350. The user interface 350 may be presented via a displayer of the system 100 or may be presented via an end-user device. As one example, the user interface 350 may be presented as a web application accessible by the end-user device.

The user interface 350 includes an example of an embodiment in which a machine learning model is being trained or being used for inference. The user interface 350 includes an option to ingest real-time sensor data. This option may enable a user to select from different data sources or sets of data sources (e.g., sensors within a particular region, sensors associated with a same purpose, and so on).

As described herein, the system 100 may determine an aggregated trust score based on the received trust information 304. The technique or algorithm to determine an aggregated trust score may be customized, or otherwise configured, by a user of the user interface 350. In the illustrated example, the user interface 350 indicates that the received sensor data (e.g., IoT data 302) has an aggregated trust score of high. In some embodiments, the aggregated trust score may represent a value from a range of values (e.g., between 0 and 100, or another arbitrary range). Particular subsets of the range may be associated with labels, such as low, medium high, or other labels. As one example, low may represent an aggregated trust score less than a first threshold, medium may represent an aggregated trust score greater than the first threshold but less than a second threshold, and high may represent an aggregated trust score greater than the second threshold. In some embodiments, the system 100 may determine an aggregated trust score using a regression model, machine learning model, and so on. In some embodiments, a machine learning model may output a label rather than a value (e.g., low, medium, high, or other labels).

The user interface 350 may allow the user to customize the technique or algorithm associated with determining an aggregated trust score. For example, the user may select the customize trust requirement option. The user interface 350 may additionally allow for the user to select a minimum trustworthiness (e.g., a minimum score or minimum label). The user interface 350 may then present data sources which are associated with at least this minimum trustworthiness. The user interface 350 may respond to selection of a data source, and the system 100 may begin receiving data from the data source. For example, the system 100 may connect via a path to the data source.

The user interface 350 may additionally allow the user view detailed trust information. This option may cause the user interface 350 to update to present the individual trust scores included in the trust information 304. In some embodiments, each node may include information reflecting trust information associated with its software and/or hardware. As an example, the information may indicate that a node has a secure boot which has increased its trust score. This information may be presented via the user interface 350.

Thus, the aggregated trust score may be used to inform whether a particular data source, or a particular path, is to be used. For certain purposes, such as training machine learning models, the IoT data 302 used may be required to have greater than a threshold aggregated data source. As described above, the system 00 may automatically sever receiving data fi the associated aggregated trust score becomes less than a threshold. The system 100 may additionally automatically update its data sources to prefer data sources which have greater than a threshold, or thresholds, aggregated trust scores.

FIG. 4A is a block diagram of example data sources 402A-N and nodes 412A-412F which form paths to the example analysis system 100. The illustrated example includes data sources and nodes which may form paths to the analysis system 100. As illustrated, each of the data sources and nodes outputs its own trust score. For a particular path from a data source to the system 100, the trust scores of the data source and the nodes which form the particular path may be provided to the system 100. For example, the trust scores may be provided as metadata.

The trust scores may be determine in substantially real-time. For example, a node may update its trust score in real-time or may periodically analyze its software and/or hardware. As one example of a real-time update, an exploit may be published (e.g., in an online repository). A node may determine that it is affected by the exploit and may lower, or set to zero, its trust score.

FIG. 4B is a block diagram of the example analysis system 100 generating an aggregated trust score 424 associated with a path from an example data source 402A. As illustrated, the data source 402A and nodes 412A, 412D have respective trust engines. These trust engines may determine their trust scores (e.g., trust scores 404A, 404C, 404G) which are provided to the system 100.

Without being constrained by way of example, a trust score may be generated by a trust engine based on the software and/or hardware associated with a device implementing the trust engine. For example, a trust score may be based on whether the device has a secure boot. As another example, the trust score may be based on whether the device has received security updates. As another example, the trust score may be based on zero trust commissioning. As another example, the trust score may be based on whether the device has a secure execution environment. As another example, the trust score may be based on whether the device has secure communications. As another example, the trust score may be based on data flow integrity information. As another example, the trust score may be based on whether the device uses secure cryptographic functions (e.g., key size, particular cryptographic function, and so on). As another example, the trust score may be based on whether the device has a secure enclave. As another example, the trust score may be based on whether the device has a secure debug. As another example, the trust score may be based on whether the device has side channel resistance of cryptographic algorithms (e.g., based on JIL rating of side channel). As another example, the trust score may be based on whether the device has secure storage. As another example, the trust score may be based on whether the device has audit log capabilities.

Thus, the trust engines may determine trust scores based, in some embodiments, on at least some of the above-described information. The trust engines may optionally be customized by a user or customer. The trust engines may additionally cryptographically protect, or otherwise secure, the trust scores so that they may not be tampered with or changed downstream.

In FIG. 4B, the analysis system 100 includes a configurable trust analysis engine 422 which generates the aggregated trust score. For example, the system 100 uses the trust scores A, C, G to determine the aggregated trust score.

### Example Flowcharts

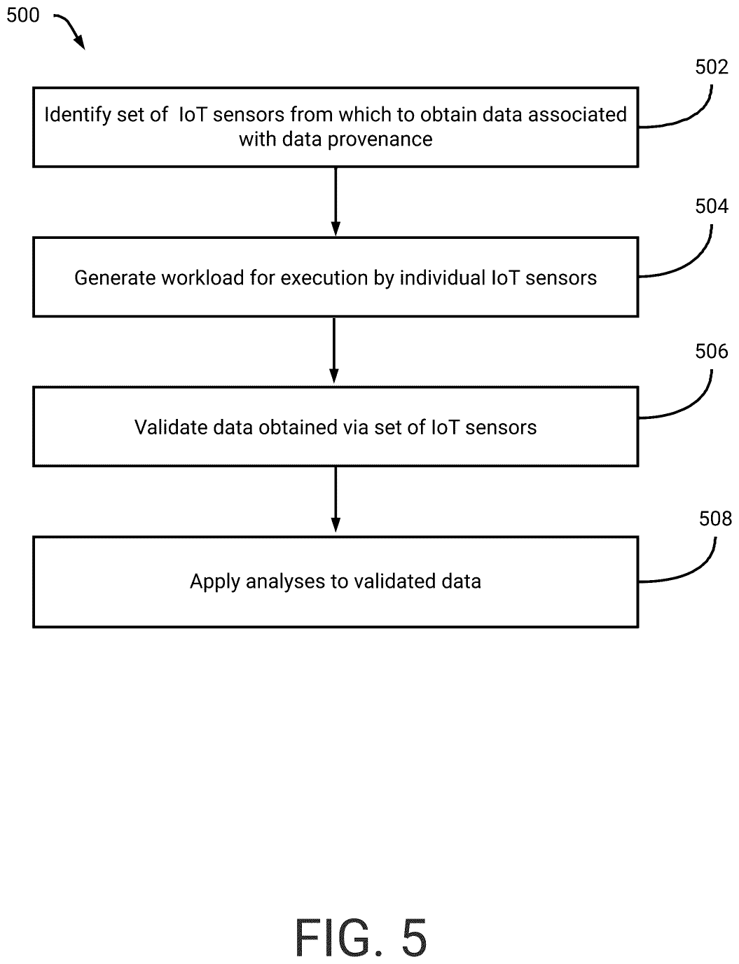

FIG. 5 is a flowchart of an example process 500 for causing aggregation of IoT data which based on a trust framework as described herein. For convenience, the process 500 will be described as being performed by a system of one or more computers or processors (e.g., the system 100).

At block 502, the system identifies a set of IoT sensors from which to obtain data associated with the trust framework. As described above, the system may receive user input reflecting constraints or queries associated with identifying IoT sensors. The system may access an index, or maintain a catalog of sensors, and present information for selection by a user. The system may additionally automatically identify sensors based on analyzing a particular use case or workload. For example, a user case may include analyzing error rates associated with a portion of a manufacturing line. In this example, the system may identify sensors associated with the portion.

At block 504, the system generates a workload for execution by individual IoT sensors. As described above, the workload may be provided to IoT sensors and identify that they are to route data back to the system or to a particular endpoint. The workload may further identify custom functionality (e.g., expanded functionality) and/or processing that the IoT sensors are to perform. As described herein, a virtual sensor may additionally form part of the identified set. The virtual sensor may reflect an abstraction associated with physical sensors, and the workload may cause the virtual sensor (e.g., an edge device, a cloud system, and so on) to perform custom processing. In some embodiments, individual workloads may be custom to individual sensors. For example, a first sensor may perform a first workload while a second sensor performs a different, second, workload.

At block 506, the system validates data obtained from the set of IoT sensors. As described herein, the sensors may include cryptographic information which persists with the data as the data travels from the IoT sensors to system or endpoint. For example, data provenance information may unique identify an originating IoT sensors. The system may validate this information, for example via a public key associated with the originating IoT sensor. The system may optionally validate nodes, such as network nodes, through which the data traveled. In some embodiments, the system may analyze trust scores as described herein. For example, the system may discard data associated with trust scores less than a threshold. The system may also update a routing of data from an IoT sensor to the system or endpoint based on the trust score. The system may also remove an IoT sensor from the set and optionally include a different IoT sensor with similar functionality.

At block 508, the system applies analyses to the validate data. The system may apply arbitrary logic and/or processing to the obtained data. For example, the system may process obtained data similar to that of stream processing and/or event processing. As an example, an IoT sensor may periodically, or substantially continuously, send time series data. For this example, the system may analyze the time series data according to user defined functionality or processing. In some embodiments, the system may leverage a library of functions which the user may select from to perform the processing.

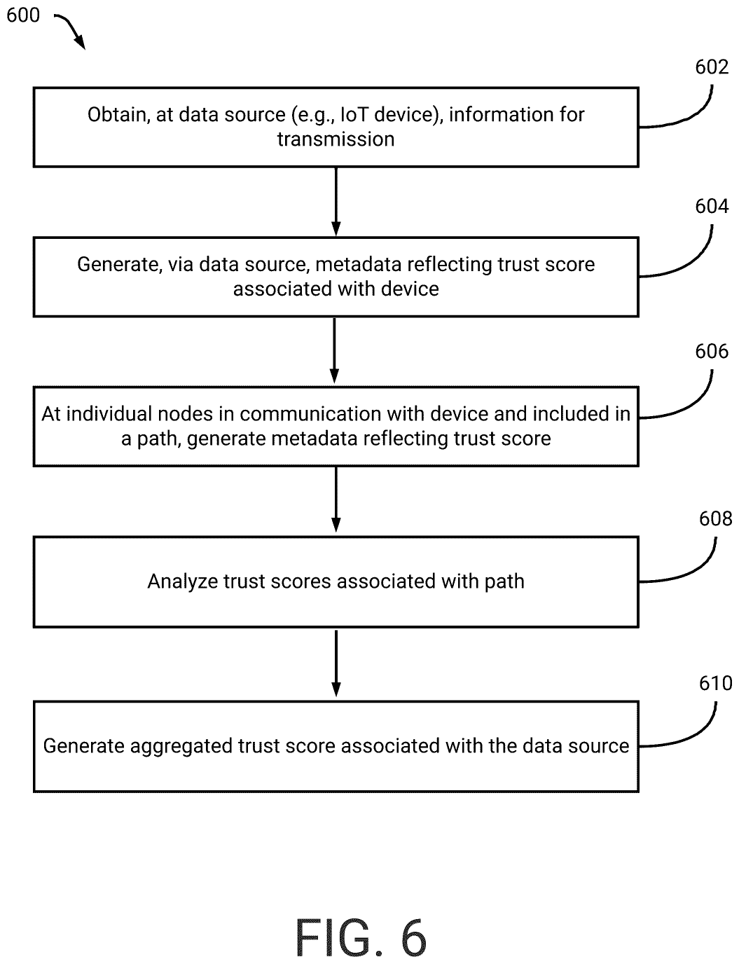

FIG. 6 is a flowchart of an example process 600 for generating an aggregated trust score associated with a data source. For convenience, the process 600 will be described as being performed by the systems and devices described herein (e.g., the system 100, a data source such as IoT device 312, nodes 314, and so on).

At block 602, a data source obtains information for transmission. The data source may represent an IoT device, such as a sensor, which measures real-world information.

At block 604, the data source generates metadata reflecting a trust score associated with the device. As described above, the data source may analyze its hardware and/or software to determine the trust score.

At block 606, individual nodes in a path generate metadata reflecting respective trust scores. Similar to the data source, the nodes may analyze their hardware and/or software to determine their trust scores.

At block 608, the system analyzes the trust scores associated with the path. The system accesses the trust scores for the data source and nodes included in the path. At block 510, the system generates an aggregated trust score. The aggregated trust score may be associated with the data source. The aggregated trust score may also be associated with the path. The aggregated trust score may thus be updated if the path to the data source changes.

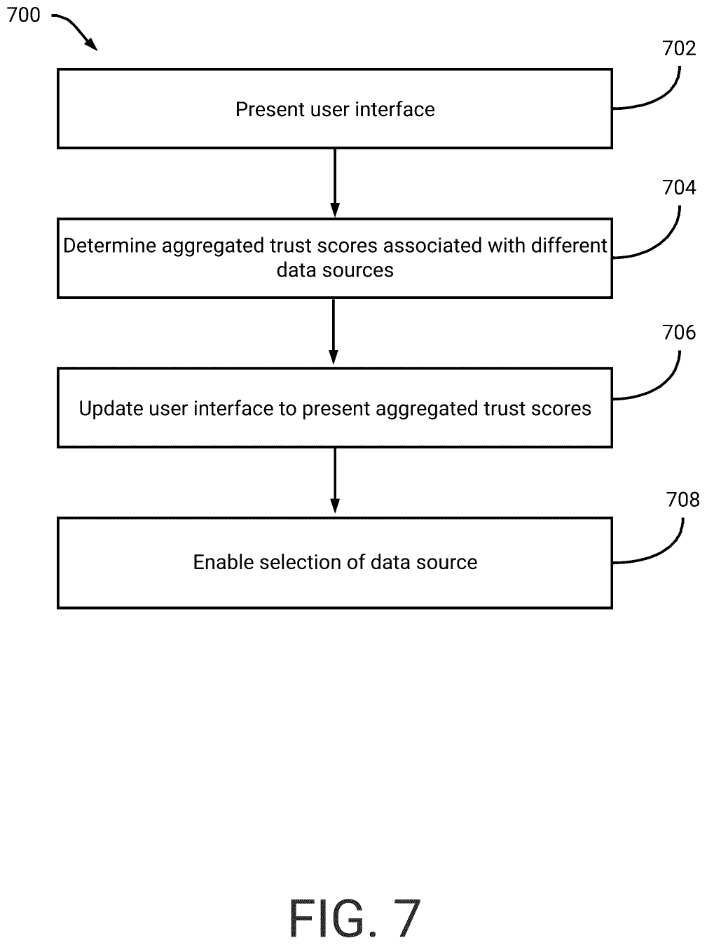

FIG. 7 is a flowchart of an example process 700 for enabling selection of a data source based on one or more aggregated trust scores. For convenience, the process 700 will be described as being performed by a system of one or more computers or processors (e.g., the system 100).

At block 702, the system presents a user interface. The user may user the user interface to understand the trustworthiness of data sources. For example, the user may select a particular set of data sources which are to be used for a purpose. In this example, the user may provide a query or other information to filter, or otherwise cause identification of, the data sources. In this way, the system may determine data sources which are able to provide data of interest to the user.

At block 704, the system determines aggregated trust scores associated with different data sources. The system may receive trust scores (e.g., as metadata) from different data sources. As described herein, the system may generate aggregated trust scores for these data sources. The system may also be capable of communicating with a data source over multiple paths. Thus, the system may have multiple aggregated trust scores for the data source with each aggregated trust score corresponding to one of the paths.

At block 706, the system updates the user interface to present the aggregated trust scores. At block 708, the system enables selection of one or more data sources. The user may identify which of the data sources meet a minimum trustworthiness. In some embodiments, the system may identify the data sources based on a constraint provided by the user (e.g., a minimum aggregated trust score). The system may also identify the data sources based on a purpose associated with the data. For example, the system may select higher trustworthy data sources for training machine learning models.

In some embodiments, the system may implemented a method that includes obtaining a set of trust scores associated with a path from a data source to the system, the path including one or more nodes, wherein the data source and the one or more nodes generate respective trust scores, and wherein a trust score is based on the hardware and/or software associated with the data source or node; analyzing the set of trust scores, and generating an aggregated trust score; causing access to, or disconnection from, the data source based on the aggregated trust score. The data source may be an internet-of-things (IoT) device. The IoT device may be an IoT sensor. The one or more nodes may include a gateway. The system may be configured to customize an algorithm associated with generating aggregated trust scores.

### Other Embodiments

All of the processes described herein may be embodied in, and fully automated, via software code modules executed by a computing system that includes one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence or can be added, merged, or left out altogether (for example, not all described acts or events are necessary for the practice of the algorithms). Moreover, in certain embodiments, acts or events can be performed concurrently, for example, through multi-threaded processing, interrupt processing, or multiple processors or processor cores or on other parallel architectures, rather than sequentially. In addition, different tasks or processes can be performed by different machines and/or computing systems that can function together.

The various illustrative logical blocks, modules, and engines described in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of computing devices, for example, a combination of a DSP and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can,” “could,” “might” or “may,” unless specifically stated otherwise, are understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is understood with the context as used in general to present that an item, term, etc., may be either X, Y, or Z, or any combination thereof (for example, X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

It should be emphasized that many variations and modifications may be made to the above-described embodiments, the elements of which are to be understood as being among other acceptable examples. All such modifications and variations are intended to be included herein within the scope of this disclosure.

1. A system comprising:
a plurality of internet-of-things (IoT) sensors, wherein individual IoT sensors are configured to generate data provenance information which, at least, cryptographically identifies data as originating from the individual IoT sensors; and
one or more processors in communication with non-transitory computer storage media storing instructions that when executed by the one or more processors, cause the one or more processors to:
determine a subset of the IoT sensors from which data is to be aggregated, the IoT sensors being responsive to one or more constraints;
instruct the subset of the IoT sensors to generate data, wherein a first IoT sensor of the subset is instructed to execute a custom workload, and wherein the data provenance information generated via the first IoT sensor is to be cryptographically signed; and
aggregate output data associated with the subset of the IoT sensors, wherein data provenance information associated with the IoT sensors is validated to form a trusted network chain.

2. The system of claim 1, wherein the one or more processors are configured to cause presentation of an interactive user interface via a user device, and wherein the interactive user interface:
presents graphical representations of a plurality of sensors which are responsive to the constraints, wherein the subset is selected based on the graphical representations,
identifies, for the first IoT sensor, expanded functionality capable of performance via the first IoT sensor, wherein the custom workload is configured to leverage the expanded functionality, and
triggers information to the subset reflecting their aggregation.

3. The system of claim 1, wherein the one or more processors are configured to:
access, for data obtained from an individual IoT sensor of the subset of IoT sensors, a public key associated with the IoT sensor; and
validate the data provenance information, wherein the individual IoT sensor is configured to generate the data provenance information based on a corresponding private key.

4. The system of claim 3, wherein upon onboarding of the IoT sensor, the IoT sensor is configured to provide the public key to an endpoint accessible via the one or more processors.

5. The system of claim 3, wherein the one or more processors are further configured to validate data provenance information supplemented via individual nodes through which the data obtained from the individual IoT sensor traveled.

6. The system of claim 1, wherein a particular IoT sensor of the subset of sensors is a virtual sensor, wherein the virtual sensor reflects an abstraction associated with a particular set of physical IoT sensors, and wherein the virtual sensor performs local processing based on information obtained via the particular set of physical IoT sensors.

7. The system of claim 6, wherein the virtual sensor validates data provenance information included in the particular set of physical IoT sensors, wherein the virtual sensor supplements the data provenance information based on cryptographically identifies data from the virtual sensor as originating at the virtual sensor.

8. The system of claim 1, wherein the data output via an individual IoT sensor includes one or more sensor measurements, metadata associated with the sensor measurements, and processing associated with a custom workload, and wherein the data is cryptographically signed via the individual IoT sensor such that the cryptographic signature persists with the data.

9. The system of claim 1, wherein an individual IoT sensor is formed from an original equipment manufacturer (OEM) sensor connected to a sensor edge element, and wherein the sensor edge element generates the data provenance information.

10. The system of claim 9, wherein the OEM sensor is connected to the sensor edge element via I²C.

11. The system of claim 9, wherein the sensor edge element is configured to perform a custom workload via one or more microcontrollers, and wherein the sensor edge element is configured to interface with control registers of the OEM sensor.

12. The system of claim 1, wherein the one or more processors are configured to determine that data output via a particular IoT sensor is unable to be validated, and wherein the one or more processors are configured to discard the data.

13. A method implemented by a system of one or more processors, the method comprising:
determining a subset of a plurality of IoT sensors from which data is to be aggregated, the subset of the plurality of IoT sensors being responsive to one or more constraints, wherein individual IoT sensors are configured to generate data provenance information which, at least, cryptographically identifies data as originating from the individual IoT sensors;
instructing the subset of the IoT sensors to generate data, wherein a first IoT sensor of the subset is instructed to execute a custom workload, and wherein the data provenance information generated via the first IoT sensor is to be cryptographically signed; and
aggregating output data associated with the subset of the IoT sensors, wherein data provenance information associated with the IoT sensors is validated to form a trusted network chain.

14. The method of claim 13, wherein the method further comprises causing presentation of an interactive user interface via a user device, and wherein the interactive user interface:
presents graphical representations of a plurality of sensors which are responsive to the constraints, wherein the subset is selected based on the graphical representations,
identifies, for the first IoT sensor, expanded functionality capable of performance via the first IoT sensor, wherein the custom workload is configured to leverage the expanded functionality, and
triggers information to the subset reflecting their aggregation.

15. The method of claim 13, wherein the method further comprises:
accessing, for data obtained from an individual IoT sensor of the subset of IoT sensors, a public key associated with the IoT sensor; and
validating the data provenance information, wherein the individual IoT sensor is configured to generate the data provenance information based on a corresponding private key.

16. (canceled)

17. The method of claim 15, wherein the method further comprises validating data provenance information supplemented via individual nodes through which the data obtained from the individual IoT sensor traveled.

18. The method of claim 13, wherein a particular IoT sensor of the subset of sensors is a virtual sensor, wherein the virtual sensor reflects an abstraction associated with a particular set of physical IoT sensors, and wherein the virtual sensor performs local processing based on information obtained via the particular set of physical IoT sensors.

19. The method of claim 18, wherein the virtual sensor validates data provenance information included in the particular set of physical IoT sensors, wherein the virtual sensor supplements the data provenance information based on cryptographically identifies data from the virtual sensor as originating at the virtual sensor.

20. (canceled)

21. (canceled)

22. (canceled)

23. The method of claim 13, wherein the method further comprises determining that data output via a particular IoT sensor is unable to be validated, and wherein the method further comprises discarding the data.

24. Non-transitory computer storage media storing instructions that when executed by a system of one or more computers, cause the one or more computers to perform operations comprising:
determining a subset of a plurality of IoT sensors from which data is to be aggregated, the subset of the plurality of IoT sensors being responsive to one or more constraints, wherein individual IoT sensors are configured to generate data provenance information which, at least, cryptographically identifies data as originating from the individual IoT sensors;
instructing the subset of the IoT sensors to generate data, wherein a first IoT sensor of the subset is instructed to execute a custom workload, and wherein the data provenance information generated via the first IoT sensor is to be cryptographically signed; and
aggregating output data associated with the subset of the IoT sensors, wherein data provenance information associated with the IoT sensors is validated to form a trusted network chain.

25. (canceled)
